(19) United States
(12) Patent Application Publication
(10) Pub. No.: US 2015/0089348 A1
(43) Pub. Date: Mar. 26, 2015

(54) SYSTEM AND METHOD FOR WEB PAGE BACKGROUND IMAGE DELIVERY

(71) Applicant: Yahoo! Inc., Sunnyvale, CA (US)

(72) Inventor: Alex Nadakkapparambil Jose, San Jose, CA (US)

(73) Assignee: Yahoo! Inc., Sunnyvale, CA (US)

(21) Appl. No.: 14/033,935

(22) Filed: Sep. 23, 2013

(51) Int. Cl. G06F 17/30; G06F 3/0484

(52) U.S. Cl. CPC G06F 17/30893; G06F 3/0484
USPC 715/234

(57) ABSTRACT

Disclosed is a system and method for progressively deploying a large size wallpaper of a web page, without compromising on image quality, perceived load time or user experience. The present disclosure involves embodiments for reducing the size of background image of a web page for initial deployment of the page. This reduced size background image maintains its high quality features; however, there is a reduction in detail resulting in a “blurred” image. Therefore, the deployed page does not reduce page performance upon attempting to download large background images. Upon serving the web page with the compressed image, higher detail versions of the compressed background image are progressively downloaded until the original high quality image is displayed.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to delivering web pages, and more particularly, to systems and methods for progressive web page background delivery.

### RELATED ART

Traffic over the world-wide-web (WWW) using the Internet continues to rapidly grow as well as the complexity and size of the information moved from sources of information to users of such information. Bottlenecks in the movement of data from web servers of content suppliers to users results in delays in information transmission and decreases the quality of the user's experience. Web traffic is still expected to increase faster than the ability to resolve data transfers over the Internet. Present techniques present various deficiencies in handling data and maximizing bandwidth usage.

### SUMMARY

The present disclosure describes systems and methods for delivering web pages, and specifically for progressively deploying a large size wallpaper of a web page, without compromising on image quality, perceived load time of the web page or user experience. The systems and methods discussed herein provide a performance solution for web pages, and in some embodiments, may be utilized as a delivery strategy for content across a content provider platform, such as, for example, Yahoo!®. As discussed herein, the present disclosure involves embodiments for reducing the size of background image of a web page for initial deployment of the page. This reduced size background image, or compressed image, maintains its high quality features (e.g., high quality JPEG); however, there is a reduction in detail resulting in a “blurred” image. Therefore, the deployed page does not reduce page performance upon attempting to download large background images, as is the case with current web page downloading/retrieving techniques. Upon serving the web page with the compressed image (i.e., after the web page is fully loaded), higher detail versions of the background image are progressively downloaded until the original high quality image is displayed. This results in a smooth, non jarring background transition that begins with the display of a high quality, yet lower size and “blurred” wallpaper as the background image of the displayed web page, and ends with the display of a high quality, high detailed wallpaper that does not compromise page load time or user experience. The disclosed systems and methods result in a better user experience. The present disclosure provides solutions applicable with all known and to be known web browsers and applications, and does not require a specific browser or application configuration.

In accordance with one or more embodiments, a method is disclosed which includes receiving, at a computing device, a request to display a web page from a user associated with a user device; identifying, via the computing device, said web page based on said request, said web page comprising web content, said web page associated with a background image having an original perceivable resolution; applying, via the computing device, a blur filter to said background image, the blur filter using settings, said settings comprising a blur radius, said blur radius set at a value that yields a modified background image having a data size at or below a data size threshold, said modified background image comprising reduced perceivable resolution when displayed; transmitting, via the computing device, said web page with said modified background image to said user device; fetching, via the computing device, said background image after initial display of said web content and said modified background image; and transmitting, via the computing device, said background image to said user device for display with said web content, wherein said transmission of said background image facilitates display of the background image at said original perceivable resolution.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for progressive web page background delivery without compromising image quality, perceived page load time and/or user experience.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a schematic block diagram illustrating components of a system in accordance with embodiments of the present disclosure;

FIG. 4 is a flowchart illustrating steps performed in accordance with some embodiments of the present disclosure;

FIGS. 5A-5F illustrate non-limiting examples in accordance with embodiments of the present disclosure with reference to FIGS. 3-4;

FIG. 6 is a flowchart illustrating steps performed in accordance with some embodiments of the present disclosure;

FIGS. 7A-7D illustrate non-limiting examples in accordance with embodiments of the present disclosure with reference to FIGS. 3 and 6; and

FIG. 8 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

Currently, given the popularity of the World Wide Web, content providers continue to look for better and faster ways to present information to users. Web pages are typically written in HyperText Markup Language (HTML), which defines how a web page looks and how a user is able to interact with the web page. The written HTML code is generally stored on a web server, where it may be accessed by a user via a software application, e.g., a web browser or other application resident on the user's computing system. Upon a user specifying a Uniform Resource Locator (URL) address of a desired web page, a web browser connects with the web server hosting the web page, fetches the HTML code for the page from the web server, and interprets the code together with any client-side scripts to construct the web page on the user's display. As known in the art, HTML provides basic document formatting of text and images and allows the developer to specify hyperlinks, or “links,” to other servers and files.

Use of an HTML compliant client, such as a web browser, involves specification of an address via a URL. Upon such specification, the client makes a TCP/IP request to the server identified in the URL and ultimately receives a “web page” (namely, a document and any accompanying graphics formatted according to HTML coding) in return. A “website” or “site” is a collection of web pages, typically hyperlinked together and accessible through a front or “home” page which is often accessed when a URL without a directory or file name is specified.

Each computing device used to display a web page may include a browser application (or browser, or in some embodiments, as discussed below, an application (or “app”)). The operation of browsers are known, but in general, user computing devices each run a version of a browser as part of their operating system capable of accessing and retrieving web pages from web servers. The browser on a computing device retrieves an electronic document, or web page from a web site, and displays the web page on a display (or monitor) associated with the device (or other output device). To view the electronic document as a web page, the user specifies a URL identifying the particular document in the browser. A URL may be specified by entering a URL character string using a user input interface, by selecting a hyperlink specifying the URL in an HTML document currently being displayed in the browser, or by selecting a URL from a list provided by the browser. In response to the entered URL, the browser generates a request command for the URL and transmits the request over a network to fetch the document using conventional Internet protocols, such as the HTTP.

As discussed herein, in accordance with the scope of embodiments of the present disclosure, a web page can include content information and background information. That is, a web page, as an information set, can contain numerous types of information, which are able to be seen, heard and/or interacted with by an end user. Thus, such information can include content information for display in the foreground of the page, and background information, for display in the background of the page. Layout, typographic and color-scheme information is provided by Cascading Style Sheet (CSS) instructions, which can either be embedded in the HTML or can be provided by a separate file, which is referenced from within the HTML.

In some embodiments, as understood by those of skill in the art, web pages may exhibit dynamic behavior, referred to as dynamic web pages. That is, client-side computer code such as JavaScript® or code implementing Ajax techniques can be provided either embedded in the HTML of a web page or, like CSS stylesheets, as separate, linked downloads specified in the HTML. These scripts may run on a client and/or server computer, in accordance with some embodiments of the present disclosure.

For purposes of this disclosure, content information includes the information or data displayed in the foreground of the web page. In general, content information usually includes text, images, video, advertisements, and/or other types of multimedia, and can also contain links to content, other pages/sites, and sometimes other types of media to be included in the final view of the page. For example, content information includes, but is not limited to, renderable content (with diverse rendering variations), textual content, non-textual information, interactive text (e.g., DHTML) animated or static content including, but not limited to raster graphics (e.g., GIF, JPEG or PNG), vector formats such as SVG, Flash®, Shockwave® or Java® Applets, and the like. Additionally, content information can also include interactive media such as, but not limited to, streaming media, graphics and the like (e.g., Windows® Media Content), Real Media® content (RM), Flash® video). Content information can also include interactive illustrations ranging from “click to play” images to games, typically using script orchestration and other types of known or to be known applets and scripts.

In general, background information includes background imagery to be displayed in the background of the page (e.g., behind the content information which is displayed in the foreground of the page). That is, background information includes, but is not limited to, images displayed in the background of the web page. In some embodiments, such images can be in the format of JPEG, however, any and all types of image formats, whether known or to be known, are applicable to the discussion herein. In some embodiments, the images displayed in the background of a page can relate to the content of the web page. For example, a web page displaying the weather for New York City may display, in the background as wallpaper of the page, an image (i.e., picture) of the New York City skyline. Indeed, in accordance with embodiments of the present disclosure, background information includes background content which can be, but is not limited to, images, video, advertisements, text, and/or other types of multimedia, and can be any combination thereof. For example, background information may display background content that includes an image and an advertisement. Thus, for purposes of discussion with reference to the present disclosure, reference will be made to background information respective images displayed in the background of a web page; however, it should not be construed as limiting the disclosure to solely images, as any and all types of content and content combinations may be displayed as the background of a web page, or electronic document.

Background images displayed on the page are associated with the web page, in that, they are provided to the user from the content provider of the page. In some embodiments, background images associated with the web page are stored on the web server as separate files. In some embodiments, in accordance with HTTP protocol, once a web page is downloaded to a browser, related files such as images and stylesheets will be requested as it is processed. For example, an HTTP web server will maintain a connection with the browser until all related resources have been requested and provided. Web browsers usually render images along with the text and other material on the displayed web page.

While reference to the systems and methods for progressive background images of web pages is made herein, it should be understood that the present disclosure can equally refer to portions of web pages, resources of a web page, and the like, without departing from the scope of the disclosure. Resources of a HTML web page include, but are not limited to, stylesheet files, Javascript and other script files, images, video and any other parts of the pages which are not embedded in the HTML.

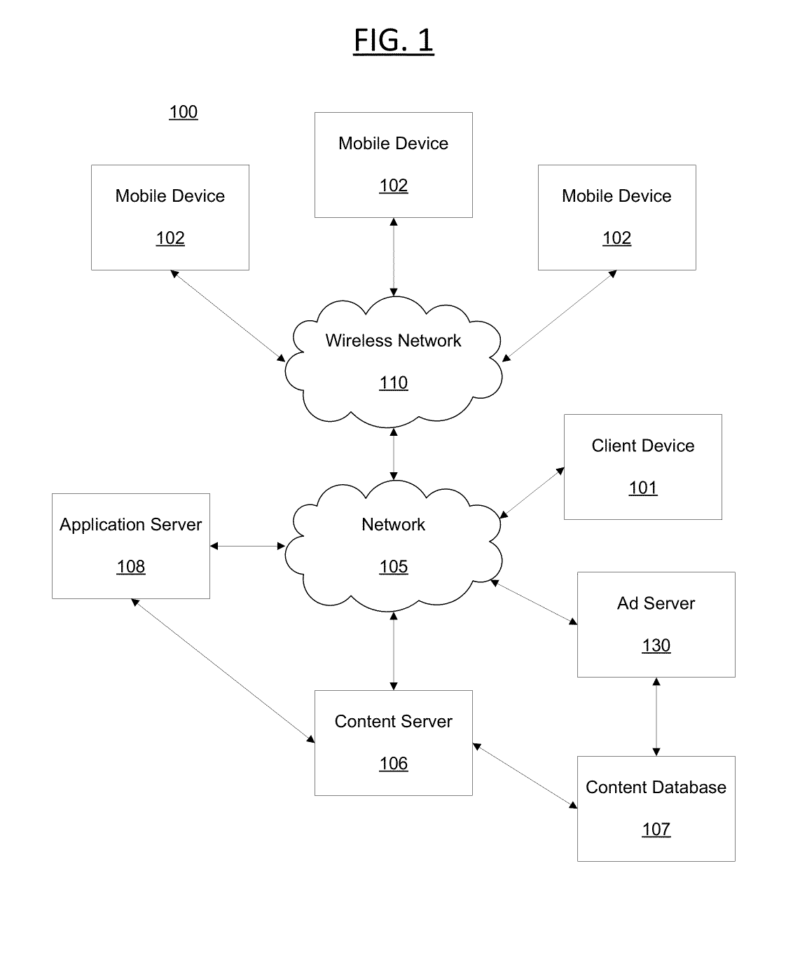

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, and advertising (“ad”) server 130.

One embodiment of mobile devices 102-103 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems, WLAN, Wireless Router (WR) mesh, and the like. Access technologies such as 2G, 3G, 4G and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content server 106, application server 108, client device 101, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site or service, such as an email platform, social networking site music site/platform (e.g., Yahoo!® Music), a movie site or platform (e.g., Yahoo!® Movies) or any other type of content hosted, retrievable, downloadable or accessible via a web page or service, or a personal user site (such as a blog, vlog, online dating site, and the like). Indeed, a content server 106 may also host a variety of sites providing any range of content, including, but not limited to, music sites, movie sites, streaming content, business sites, educational sites, dictionary sites, encyclopedia sites, wikis, financial sites, government sites, and the like. In some embodiments, the content server 106 may also provide advertising or marketing content. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, email services, instant messaging (IM) services, SMS services, MMS services, FTP services, voice over IP (VOIP) services, or the like. Such services, for example the email services and email platform, can be provided via the content server 106. Examples of content may include images, text, audio, video, or the like, which may be processed in the form of physical signals, such as electrical signals, for example, or may be stored in memory, as physical states, for example.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by servers 106, 108 and/or 130. This may include in a non-limiting example, email servers, social networking services servers, SMS servers, IM servers, MMS servers, exchange servers, photo-sharing services servers, and travel services servers, via the network 105 using their various devices 101-104. In some embodiments, applications, such as a photo-sharing or viewing application (e.g., Flickr®, Instagram®, and the like), can be hosted by the application server 108. Thus, the application server 108 can store various types of applications and application related information including application data and user profile information. In another example, a content server 106 acting as an email server can host email applications; therefore, the content server 106 can store various types of applications and application related information including email application data and user profile information, which can be correlated with the application server 108. It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108 and 130 as single computing devices, respectively, the disclosure is not so limited. For example, one or more functions of servers 106, 108 and/or 130 may be distributed across one or more distinct computing devices. Moreover, in one embodiment, servers 106, 108 and/or 130 may be integrated into a single computing device, without departing from the scope of the present disclosure.

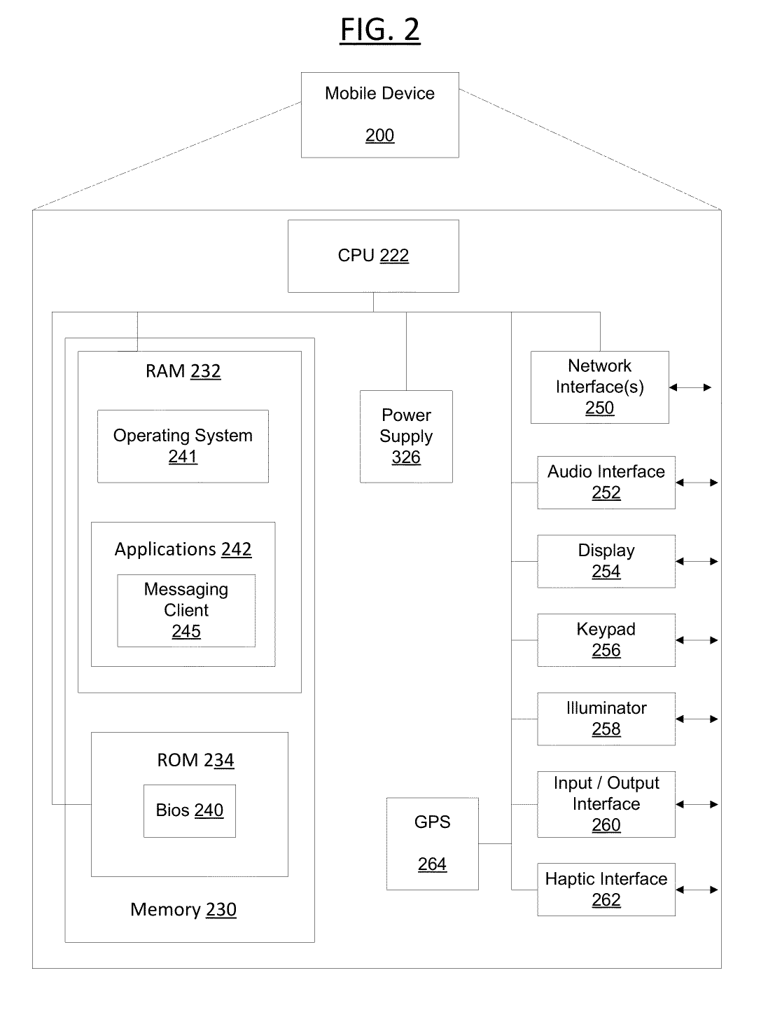

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email, VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

Having described the components of the general architecture employed within the disclosed systems and methods, the components' general operation with respect to the disclosed systems and methods will now be described. The principles described herein may be embodied in many different forms.

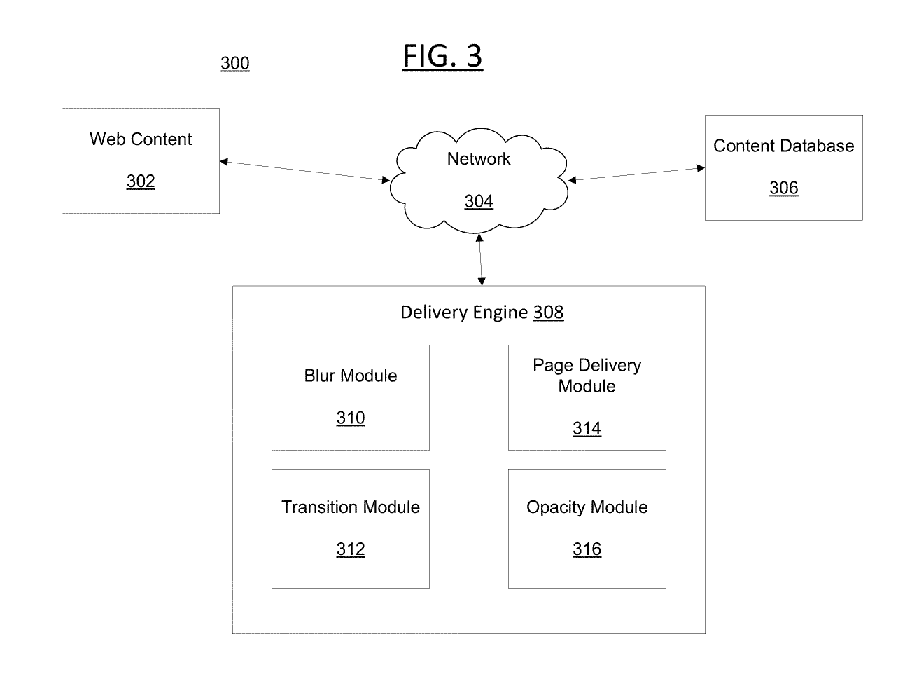

FIG. 3 is a block diagram illustrating the components of system 300 for performing the systems and methods discussed herein. FIG. 3 includes network 304, a delivery engine 308, web content 302 hosted by, for example, a content provider 106 as discussed above, and a content database 306 (similar to the content database discuss above, item 107). The delivery engine 308 could be hosted by a web server, content provider, application service provider, advertisement server, a user's computing device, or any combination thereof. As discussed above, the web content 302 (or web page) can be any type of content, and includes content information and background information. The web content 302 can be provided to the delivery engine 308 or accessed by a computer program or device that can access the web content 302. In some embodiments, the web content 302 can be stored in a database of stored content 306, which is associated with a content platform/provider, such as Yahoo!®. In some embodiments, as discussed herein, the web content 302 can be advertisement information provided by the ad server 130. The database 306 can be any type of database or memory that can store the web content, as discussed above. For purposes of the present disclosure, web content is discussed within some embodiments; however, it should not be construed to limit the applications of the systems and methods discussed herein. Indeed, while reference is made throughout the instant disclosure to accessing, retrieving and displaying web content on web pages, other forms of electronic documents or transmissions (e.g., electronic mail messages (“e-mail”)) can be received and/or accessed and processed by the delivery engine 308 according to the systems and methods discussed herein.

As discussed above, with reference to FIG. 1, the network 304 can be any type of network such as, but not limited to, a wireless network, a local area network (LAN), wide area network (WAN), the Internet, or a combination thereof. The network 304 facilitates connectivity between the web content 302, the delivery engine 308, and the database of stored resources 306.

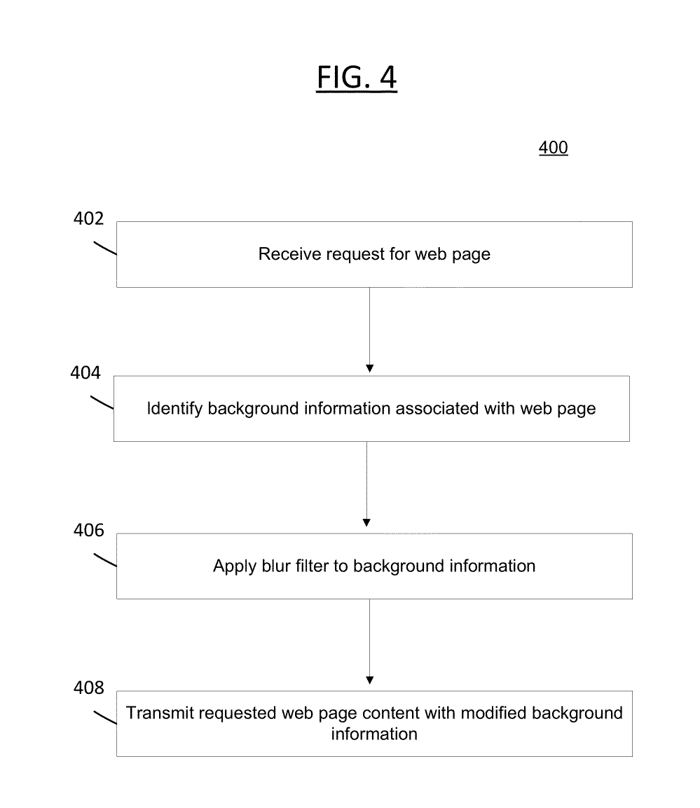

The delivery engine includes a blur module 310, page delivery module 312, transition module 314 and an opacity module 316. It should be understood that the engine(s) and modules discussed herein are non-exhaustive, as additional or fewer engines and/or modules may be applicable to the embodiments of the systems and methods discussed. The operations, configurations and functionalities of each module, and their role within embodiments of the present disclosure will be discussed with reference to FIGS. 4-7, whereby the components of system 300 are implemented to perform the steps and processes discussed below.

FIG. 4 is a process 400 diagram illustrating steps performed in accordance with embodiments of the present disclosure. As discussed above, the present disclosure generally involves gradually improving the perceived resolution of a web page's background image (or wallpaper) without compromising image quality of the background image, web page load time or a user's experience on the web page. Currently, background images are typically a performance bottleneck on most web pages. In some embodiments they are typically displayed for “eye-candy” or to increase the user's experience. In some embodiments, they involve functionality respective the user's experience where they may display an advertisement or other content with the ability for the user to interact with, thereby providing click-through capability. However, until the background image is fully loaded, such large size image backgrounds are usually a user experience “deal breaker”, that is extended load times diminish the overall user experience. Such is the case due to background images typically being very large in size, e.g., between 300 KB to several megabytes. Additionally, background images may require considerable bandwidth and time to download, which may compete with or starve other resources (e.g., content information) on the web page which are being downloaded in parallel.

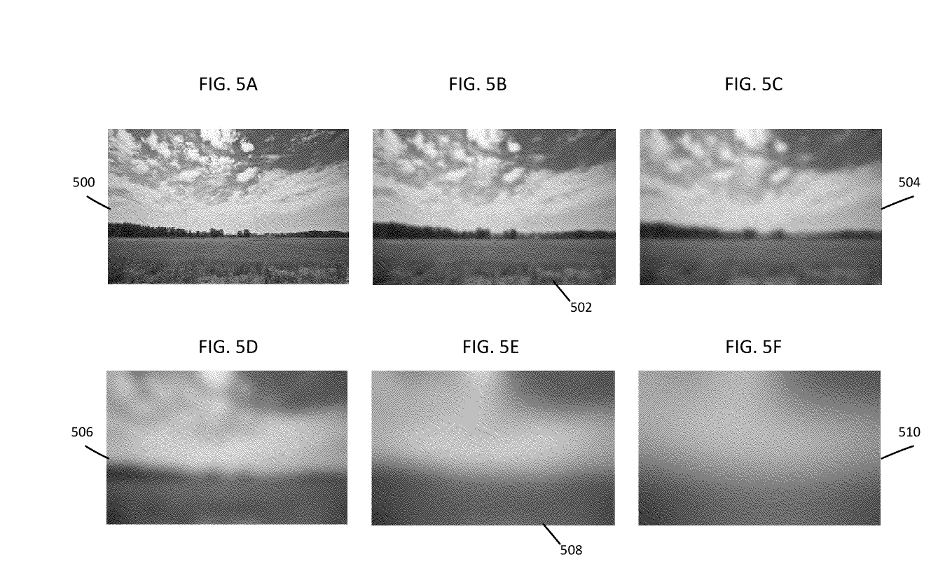

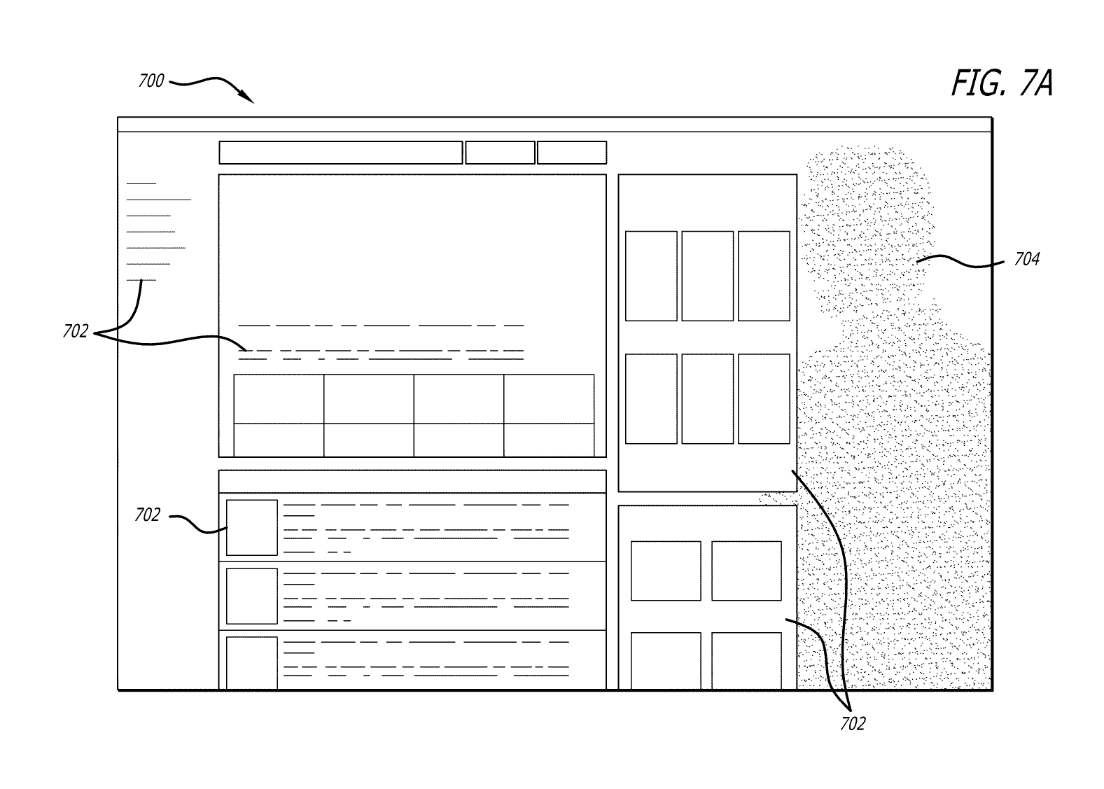

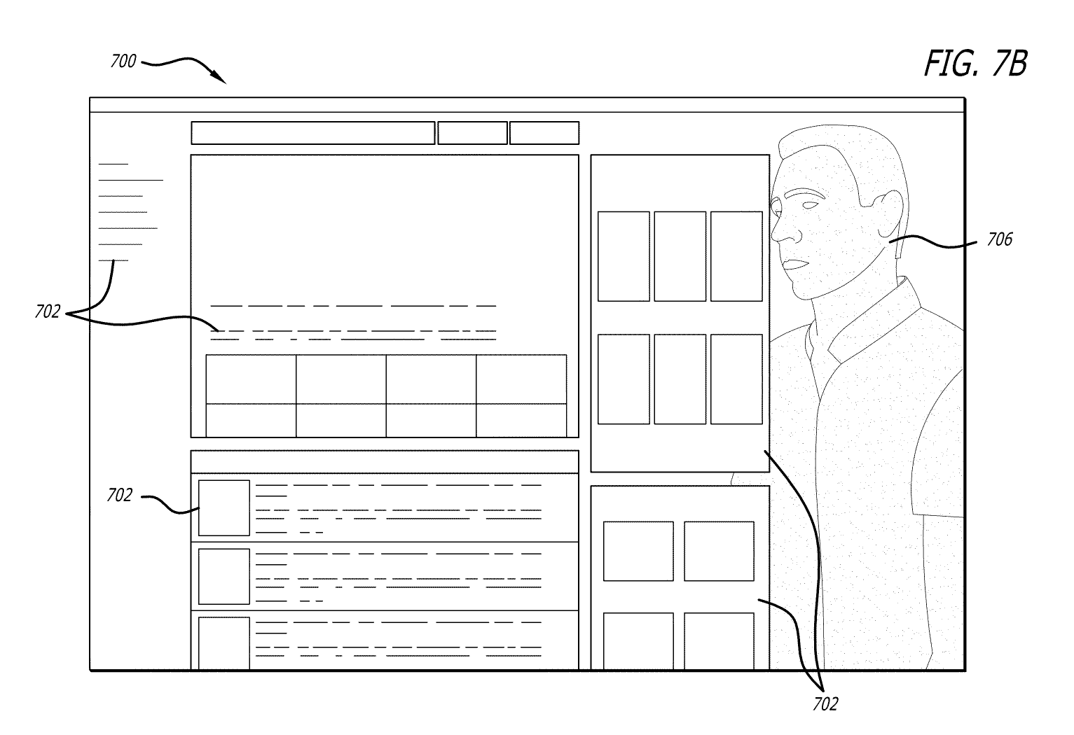

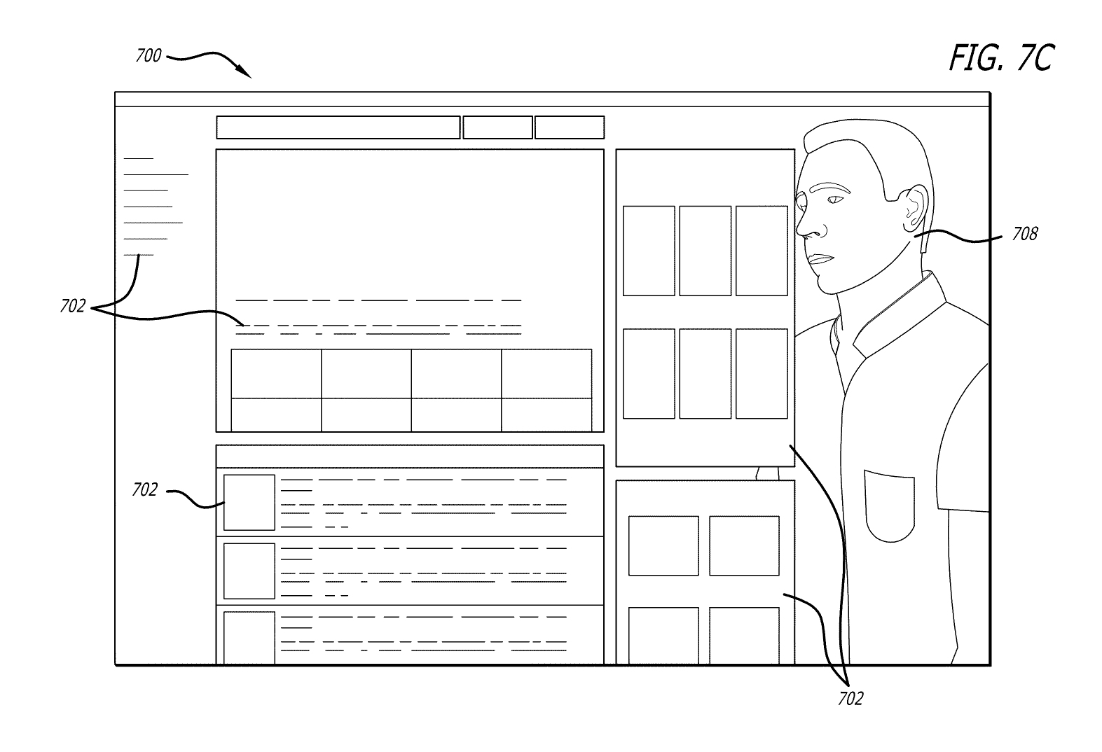

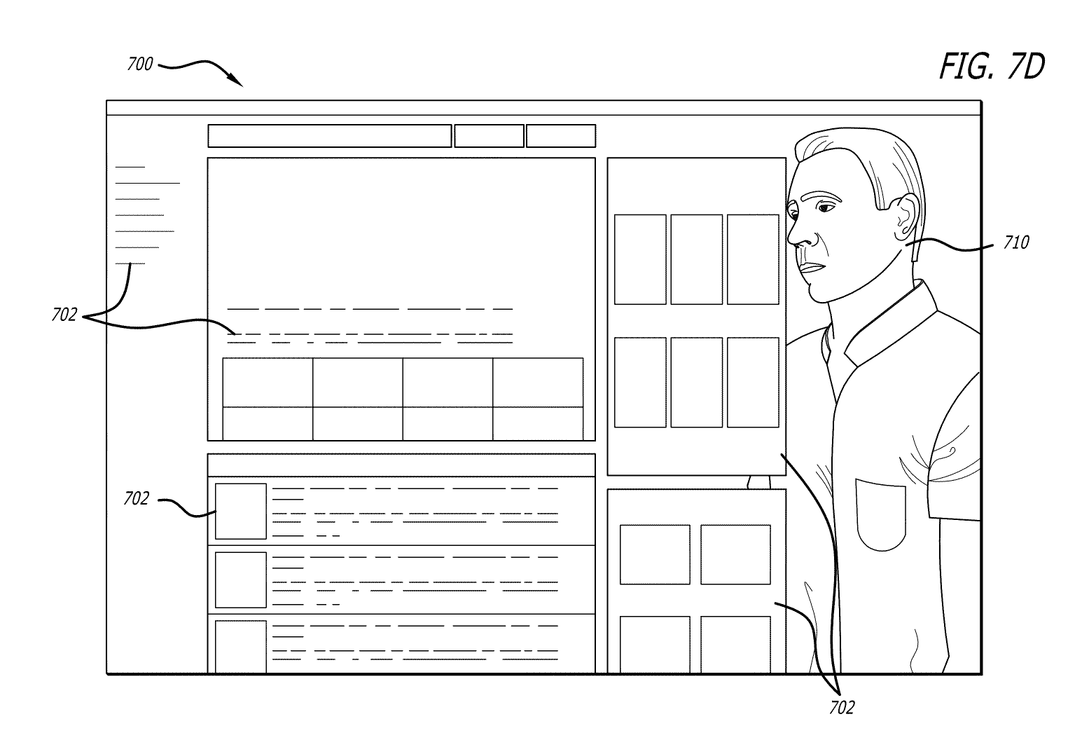

The present disclosure remedies fallbacks with current techniques by initially transmitting a web page with a reduced data size or diminished detail background image. In other words, less image detail (or in some embodiments fewer background image bits) are sent initially to permit page content to load, while the background image gradually improves in detail for ideal viewing. This reduced data size background image, which in some embodiments may be referred to as a blurred and/or compressed image, maintains its high quality features from its original high quality version, however, there is a reduction in detail. Thus, as discussed below, and illustrated in FIGS. 5A-5F and FIGS. 7A-7D, the result of the reduced size image is a “blurred image,” which is displayed until the ultimate download and display of the original higher resolution image, as discussed in more detail below. In accordance with embodiments of systems and methods discussed herein, the present disclosure involves high-quality content (e.g., images) for each step in Processes 400 and 600. As discussed in more detail below, while the file size for reduced size images remains low (e.g., below a threshold) due to an applied blur radius, each image is progressively rendered thereby ensuring high-quality imagery.

Process 400 is effectuated via implementation of the blur module 310 illustrated in FIG. 3. The blue module 310 implements a blur filter running a blur algorithm on the original background image of the web page. In some embodiments, as discussed herein, the blur module 310 utilizes a Gaussian blur filter; however, it should not be construed to be so limiting, as the present disclosure, specifically the blur module 310, may utilize any known or to be known blurring (or smoothing) algorithms, in accordance with the systems and methods discussed herein.

Process 400 begins in Step 402 when a user requests a web page. This request for a web page constitutes a request for web content to be displayed on the web page. As discussed above, the web content of a web page includes content information and associated background information. The background information, according to embodiments of the present disclosure, is a background image (also referred to as wallpaper); however, as discussed above, can be any type of content or content combination. In Step 404, the web content is analyzed (or in some embodiments parsed) to identify the background information associated with the web page. In some embodiments, the background information may already be associated with the content information; therefore, such information may need to be extracted. In some embodiments, the background information may be associated with the content information, but stored in a separate database or previously separated from the content information; therefore, Step 404 involves identifying the background information associated with the web page. In some embodiments, the background information may be based on the type of content information requested; therefore, Step 404 involves requesting background information based on the type of content and/or specifics of the content included in the content information.

That is, Step 404 generally involves identifying the background image associated with the requested web page. In some embodiments, images associated with the web page are stored on the web server as separate files, but, as with HTTP, this allows for the fact that once a web page is downloaded to a browser, it is quite likely that related files such as images and stylesheets will be requested as it is processed. For example, an HTTP web server will maintain a connection with the browser until all related resources have been requested and provided. Web browsers usually render images along with the text, images and/or other material on the displayed web page. Thus, as in Step 404, the page delivery module 314 of the delivery engine 308 must identify, and in some embodiments parse, the background information from the content information in order to identify the background imagery to blur, as discussed below.

In Step 406, the blur module 310 applies the blur filter to the identified background information. As discussed above and for purposes of this disclosure, the background information comprises image content (or an image). Therefore, according to some embodiments, the blur module 310 applies a Gaussian blur filter to the original sized background image. By running the original, large size image through a Gaussian blur filter of different radii, the blur module 310 can produce a high quality image (e.g., JPEG) that contains reduced detail of the original image, while having a very high compression ratio. For example, the blur filter can apply radii of 100 pixels, 50 pixels, 25 pixels, and the like. Thus, based on a variant blur radius, a high detailed 1 MB image can be reduced to 20 KB via a blur radius of 100 pixels, for example.

Illustrated in FIGS. 5A-5F are examples applications of a Gaussian blur filter on an originally sized 591 KB image. FIG. 5A illustrates image 500, which is the original, large sized image which can be a background image of a web page. As in FIG. 5A, there is no blur, therefore, the image maintains its original characteristics. FIG. 5B illustrates an application of a 5 pixel blur radius, which results in the originally sized 591 KB image to be compressed to 46 KB. As seen in FIG. 5B, the image clarity (or focus) is reduced; however, as understood by those of skill in the art, by running the original image through the blur filter, the image quality and properties are maintained, and only the perceived focus of the image is reduced due to the compressed version of the image. FIG. 5C illustrates an example of the original image display due to an application of a 10 pixel blur radius resulting in a 35 KB image. FIG. 5D illustrates an application of a 25 pixel blur radius resulting in a 23 KB image. FIG. 5E illustrates an example of an application of a 50 pixel blur radius which results in a 19 KB image; and FIG. 5F illustrates yet another example of an application of a variant blur radius, where here the applied blur radius of the blur filter is 99 pixels, which results in the 591 KB image being reduced to 16 KB. As seen in FIGS. 5B-5F, increasing the blur radius results in increased “blurring” of the image. Such “blurring” can be explained to solely reduce the focus of the image, as the remaining qualities of the image remain due to the compression of the original image resulting from the application of the blur filter by the blur module 310.

In Step 408, the “blurred” (i.e., reduced or compressed) image is transmitted with the content information in response to the web page request, as discussed in more detail below and illustrated in FIG. 7A. That is, the content information (e.g., web page content) and the modified background information are transmitted to the requesting user device for display. This transmission and display is effectuated via the page delivery module 314. The content information, which is displayed in the foreground of the web page, is displayed in an unmodified state, and remains unmodified throughout processes 400 and 600. The background information is displayed as in a modified state, as discussed above, where the background image is displayed as a reduced size image version of the original image version. As an overview, Process 400 begins with an originally sized and unmodified version of the background image and performs filtering to produce a heavily blurred version of the web page's wallpaper. This filtering impacts the deployment of the web page to the requesting user as the download of the page background to the user's device does not reduce page performance.

According to some embodiments, the blur module 310 applies (and/or selects) a blur radius that yields a final image size at or below a size threshold (e.g., 20 KB or less) for the default load image. That is, in Step 406, the blur module 310 applies a blur radius that results in the image being reduced (or compressed) to at least the size threshold, e.g., 20 KB. Thus, from the examples in FIG. 5A-5F, example embodiments of blur filtering of the original 591 KB image can be found in FIG. 5E and FIG. 5F, as such filtering resulted in image sizes 19 KB and 16 KB, respectively. Therefore, according to some embodiments, Step 404 can also include a determination step where the blur module, based on the original size of the original background image, determines an applicable blur radius to apply to the original image in order to effectuate a reduce size image satisfying the 20 KB threshold. In some embodiments, such size threshold may be set according to system requirements or settings, user preference, web browser settings, image and performance requirements, network system requirements, availability or settings, and the like, and any combination thereof. Additionally, it should be understood that the size threshold can be any value which leads to yields in performance improvements of web page loading, as discussed herein.

As discussed herein, the reduction of the original background image to at least 20 KB or less upon initially providing a requesting user the web page provides a download of a high quality page background that loads as fast as system functionality and bandwidth allow, thereby avoiding the need to depend on an alternate background color or image, or separate static image that is entirely different from the final background to be displayed. Thus, the present disclosure remedies performance bottlenecks of attempting to deploy content information and background information of a web page, thereby further avoiding a deteriorated user experience without compromising image quality or perceived load time of the web content (e.g., content information and background information). That is, deploying the smallest possible background image upon initial transmission of the web page (e.g., below 20 KB, at least) provides the best possible performance for rendering the content information.

In accordance with embodiments of the systems and methods discussed herein, all the background images can be high-definition images. Thus, known and to be known image resolution and quality values of the highest quality and clarity are applicable to the present disclosure. It should be understood by those of skill in the art that the reduced size images are simply of smaller size and lack less information and detail in display, in that they still retain their high-definition values due to only the compression (e.g., reduction) occurring from the Gaussian (or other) blurring.

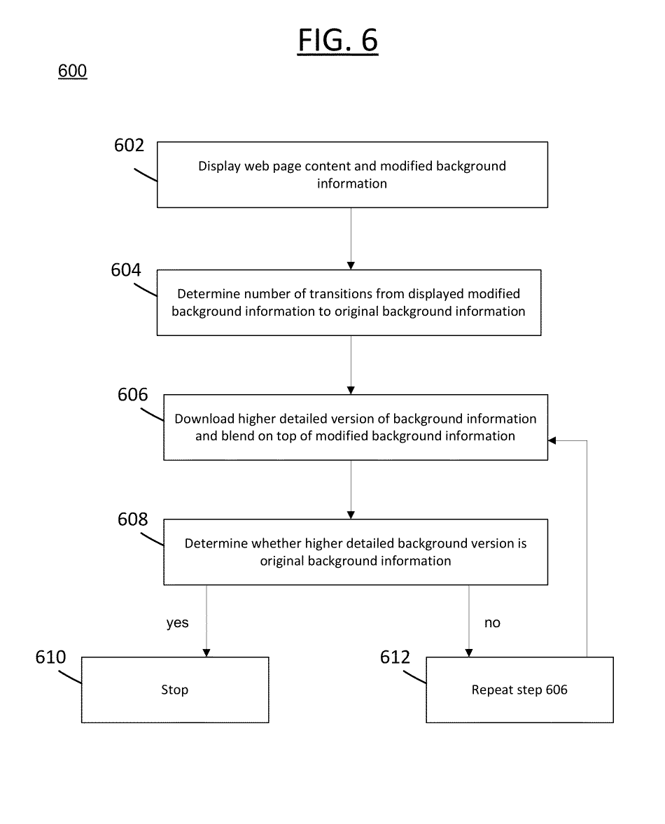

Turning to FIG. 6, Process 600 begins upon the page delivery module's 314 completion of the transmittal and display of the requested web page. Step 602. As discussed above, the initial deployment of the web page, from Step 408, includes the transmission and display of the content information (e.g., web content) and modified background information, which includes the reduced size background image. This is illustrated in FIG. 7A, where the requested web page 700 is displayed. The page 700 includes the content information 702 and the reduced size (or “blurred”) background image 704. It should be understood that the reduced size background image, which is produced from the blur module 310, as discussed above in Step 406, is the displayed background image 704.

As discussed herein, after initial deployment of the content information and modified background information, at least one higher detailed version of the reduced size image is downloaded to the client device. That is, according to some embodiments, the minimum required steps (or transitions) for downloading and displaying the original background image is two. The first step being the display of the reduced size wallpaper, and the second step including the download of the original image. In other words, the first step includes the max-blurred, least size image, and the second step includes the least-blurred, max-size image.

Within Process 600, the subsequent download of the original image, or less-blurred and increased sized images provides progressively enhanced imagery that is not competing with other resources on the web page. That is, after initial download of the content information and modified background information, resources of the web page can then be dedicated to the download of the original, large size web page background. According to some embodiments, an embedded JavaScript® can trigger and effectuate the downloading (or fetching) of higher detailed image versions in a progressive manner. From Steps 408 (and Step 602) there already exists a blurred background displayed on the page; thus, the subsequent background image download involves a smooth transition from the blurred image to the original clear/focused image, which includes a slow blend of images without any jarring, as discussed below.

In Step 604, a determination is made by the transition module 312 regarding how many steps/transitions should occur from the initial download of the blurred, reduced size image and the original, most detailed image version. The determination forms the basis for how smooth the transition from the most blurred image version (from Step 408) to the original image download. In some embodiments, such determination is in accordance with requirements set by or associated with the browser or application displaying the page, an application developer, content provider, system as a whole, network, user, and/or any combination thereof. In some embodiments, the determination in Step 604 can also or alternatively be based upon the blur radius utilized in the blurring of the image (from Step 406). For example, the higher the blur radius, which results in a smaller compressed image, may lead to additional steps in effectuating a smooth transition from the initial display of the reduced wallpaper to the final display of the original wallpaper. In some embodiments, the determination regarding the number of steps included in the transition may also or alternatively be based upon a differential between the original image's size and the reduced image size. In some embodiments, the determination of steps may also or alternatively depend on the time for ultimately loading (fetching and/or downloading) the original image. In some embodiments, the number of steps in the transition may also or alternatively be based on avoiding slowing down other processes the user is running or using on the user's device. However, regardless of how the transition occurs, in all embodiments the transition is a smooth transition, which occurs without any jarring, and is perceived as a seamless transition.

In Step 606, a higher detailed (e.g., resolution) version of the reduced background image is downloaded and blended on top of the previously displayed image via the opacity filter 316. As discussed above, the minimum number of steps is two. Therefore, according to some embodiments, after the initial display of the reduced size image, next step involves the downloading and blending of the original image on top of the initially deployed image. By way of example, the initially deployed background image 704 is the blurred image shown in FIG. 7A. In the two step embodiment, the next step would be to download and blend background image 710 on top of image 704, as illustrated in FIG. 7D. Background image 710 is the original, unmodified background image. Thus, as from the above discussion, image 704 was produced by running a blur filter (e.g., Gaussian blur filter) on image 710, where image 704 was initially displayed only until the initial page load of the content information and image 704 were completed. From here, image 710 was downloaded and blended on top of image 704, whereby the result includes the originally requested web page 700 being displayed: content information 702 and background information: image 710, as illustrated in FIG. 7D.

The opacity filter 316 smoothly applies the downloaded image on top of previously displayed image without any jarring in the transition, which includes adjusting transparency of the newly overlaid image to produce a seamlessly perceived transition from the originally displayed image to the newly displayed image. Therefore, from the above example of transitioning from FIG. 7A to FIG. 7D, the opacity of overlaid image 710 on top of image 704 is adjusted so that the user's experience with the page is uninterrupted and the user is unable to identify such process is occurring.

In Step 608, a determination is made as to whether the image overlaid and displayed from Step 606 is the original background image associated with the web page. If it is, the process completes as the requested web page is fully displayed in its final state. Step 610 (as depicted in FIG. 7D). If the determination of Step 608 results in an identification that the page is not displayed with the original version of the web page background (as depicted in FIGS. 7B and/or 7C), the Step 606 is repeated until the original background is displayed. Step 612. In some embodiments, Step 608 may be unnecessary as the transition determination from Step 604 can govern the subsequent download of higher resolution versions of the web page background. That is, the transition determination in Step 606 may identify to the delivery engine 308 that the recently blended image is not the final background image as subsequent transitions remain. In some embodiments, Steps 604 and 608 may be performed concurrently in order to accurately display the final version of the web page. It should be understood that the transition from the initial display of the web page background to the final version (e.g., display of the original image background) involves a smooth transition that is similar to focusing a lens, where the image is smoothly and efficiently brought into the highest detail and least blurred version.

By way of a non-limiting example, FIGS. 7A-7D illustrate the steps of Process 600. FIG. 7A illustrates the display of the reduced size (compressed) image 704 for the web page 700, as discussed in Step 602. Step 604, as discussed above, involves determining the steps of the transition from the image 704 to image 710 (or the initially displayed reduced size image 704 to the original, large size image 710). In this example, which is not to be construed as limiting the present disclosure, the transition steps have been determined to be 3, as illustrated in FIGS. 7B-7D. For example, in Step 606, image 706 is downloaded and blended on top of image 704, as displayed in FIG. 7B. Image 706 is displayed at 20% opacity of progress to the final image. Thus, image 706 is a higher detailed version of initially deployed image 704. However, since image 706 is not the original, large size and fully detailed image version associated with web page 700 and content information 702, a subsequent download (or step) must occur. Thus, as shown in FIG. 7C, image 708 is downloaded and blended on top of image 706. Image 708 is displayed at 50% opacity of progress to the final image. Image 708 is a higher quality, less blurred version of image 706, and is displayed in the background of the web page 700 behind the content information 702 which is displayed in the foreground. Again, since image 708 is not the original, large size image, another download iteration must occur. Thus, as shown in FIG. 7D, image 710 is downloaded and blended on top of image 708. Image 710 is displayed with an opacity of 100% because it is the fully loaded final (or original) image. Image 710 is the original, large size image associated with the web page 700; therefore, Process 600 stops as the final version of the web page has been displayed to the requesting user.

In accordance with embodiments respective the above discussion for FIGS. 7A-7D, the opacity change from 0 to 100% occurs at each step; that is, after a frame is downloaded, it is smoothly transitioned from 0% opacity to 100% opacity, effectively replacing the previous frame with a new one, as discussed above. If one more higher-detail frame is to be downloaded, the same is performed (i.e., after a frame is downloaded, it is smoothly transitioned from 0% opacity to 100% opacity, effectively replacing the previous frame with a new one) and again the same transition from 0% opacity to 100% opacity is applied on the new image. According to embodiments of the present disclosure, the opacity filter effectuates a smooth transition in realizing a higher definition image on top of the current image.

In accordance with the present disclosure, embodiments exist where Process 600 may not complete or progress to the final display of the web page (i.e., Step 608). That is, the download of the original large size image may not occur due to factors including, but not limited to, user preference, system settings, network connectivity or available bandwidth and the like, and/or any combination thereof. Thus, in some embodiments, display of a background image version may conclude with a version that is not the original version. Therefore, from the above example, a final web page display may conclude with any of the illustrations in FIGS. 7A-7C, for example.

As discussed above, it should be understood that the transition and opacity steps (Steps 604-606) occur in a sequential manner and are seamless in that they are occurring in as near of real-time as possible. Thus, the result is a seamless transition from a blurred version of the original image to an un-blurred version of the original image, which is undetectable to the user, as it occurs without any jarring or inhibition to the user' experience or perception of the web page as a whole.

In some alternative embodiments, in accordance with the above discussion respective Process 600, the opacity steps concerning the progressive download involve downloading remaining bits of images in order to effectuate the transition from the blurred image to the original image.

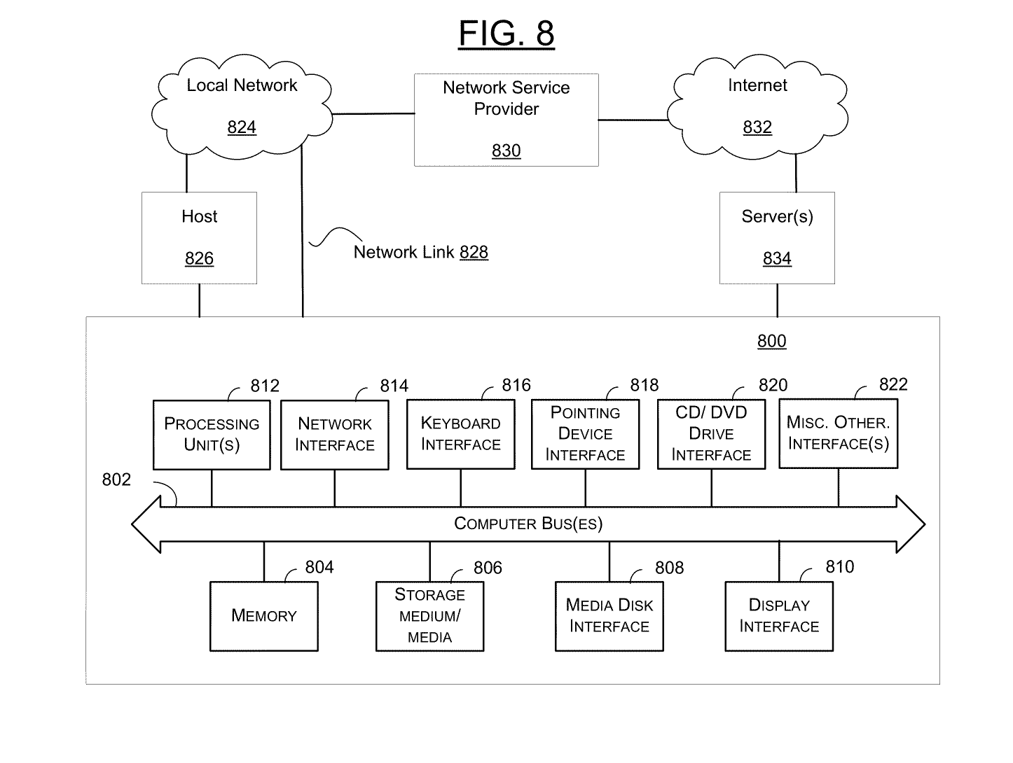

As shown in FIG. 8, internal architecture 800 includes one or more processing units, processors, or processing cores, (also referred to herein as CPUs) 812, which interface with at least one computer bus 802. Also interfacing with computer bus 802 are computer-readable medium, or media, 806, network interface 814, memory 804, e.g., random access memory (RAM), run-time transient memory, read only memory (ROM), media disk drive interface 820 as an interface for a drive that can read and/or write to media including removable media such as floppy, CD-ROM, DVD, media, display interface 810 as interface for a monitor or other display device, keyboard interface 816 as interface for a keyboard, pointing device interface 818 as an interface for a mouse or other pointing device, and miscellaneous other interfaces not shown individually, such as parallel and serial port interfaces and a universal serial bus (USB) interface.

Memory 804 interfaces with computer bus 802 so as to provide information stored in memory 804 to CPU 812 during execution of software programs such as an operating system, application programs, device drivers, and software modules that comprise program code, and/or computer executable process steps, incorporating functionality described herein, e.g., one or more of process flows described herein. CPU 812 first loads computer executable process steps from storage, e.g., memory 804, computer readable storage medium/media 806, removable media drive, and/or other storage device. CPU 812 can then execute the stored process steps in order to execute the loaded computer-executable process steps. Stored data, e.g., data stored by a storage device, can be accessed by CPU 812 during the execution of computer-executable process steps.

Persistent storage, e.g., medium/media 806, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 828 typically provides information communication using transmission media through one or more networks to other devices that use or process the information. For example, network link 828 may provide a connection through local network 824 to a host computer 826 or to equipment operated by a Network or Internet Service Provider (ISP) 830. ISP equipment in turn provides data communication services through the public, worldwide packet-switching communication network of networks now commonly referred to as the Internet 832.

A computer called a server host 834 connected to the Internet 832 hosts a process that provides a service in response to information received over the Internet 832. For example, server host 834 hosts a process that provides information representing video data for presentation at display 810. It is contemplated that the components of system 800 can be deployed in various configurations within other computer systems, e.g., host and server.

At least some embodiments of the present disclosure are related to the use of computer system 800 for implementing some or all of the techniques described herein. According to one embodiment, those techniques are performed by computer system 800 in response to processing unit 812 executing one or more sequences of one or more processor instructions contained in memory 804. Such instructions, also called computer instructions, software and program code, may be read into memory 804 from another computer-readable medium 806 such as storage device or network link. Execution of the sequences of instructions contained in memory 804 causes processing unit 812 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 800. Computer system 800 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 802 as it is received, or may be stored in memory 804 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device, a request to display a web page from a user associated with a user device;
identifying, via the computing device, said web page based on said request, said web page comprising web content, said web page associated with a background image having an original perceivable resolution;
applying, via the computing device, a blur filter to said background image, the blur filter using settings, said settings comprising a blur radius, said blur radius set at a value that yields a modified background image having a data size at or below a data size threshold, said modified background image comprising reduced perceivable resolution when displayed;
transmitting, via the computing device, said web page with said modified background image to said user device;
fetching, via the computing device, said background image after initial display of said web content and said modified background image; and
transmitting, via the computing device, said background image to said user device for display with said web content, wherein said transmission of said background image facilitates display of the background image at said original perceivable resolution.

2. The method of claim 1, wherein said application of said blur filter comprises:
determining the size of the background image;
selecting the value of the blur radius based on said size of the background image and the size threshold; and
applying the blur filter to said background image in accordance with said blur radius.

3. The method of claim 1, wherein said transmission of said web page with said modified background image comprises:
facilitating visible display of the web content in the foreground of modified web page; and
facilitating visible display of the modified background image in the background of the web page.

4. The method of claim 1, further comprising:
determining a number of transitions between the modified background image to the background image in order to effectuate a smooth, non jarring transition from display of the modified background image to display of the background image;
fetching at least one second version of the background image prior to said fetching of said background image, said second version of the background image being a higher detailed version of the background image than said modified background image version; and
transmitting said second version to said user device for display with said web content, wherein said transmission of said second version facilitates blending of said second version on top of the displayed modified background image.

5. The method of claim 4, wherein said transmission of said background image further comprises facilitating blending of said background image on top of the displayed second version of the background image.

6. The method of claim 4, wherein said number of transitions between the modified background image to the background image is based upon at least one of the blur radius and size of the background image.

7. The method of claim 1, wherein said blending of said background image on top of the displayed modified background image comprises applying an opacity filter to said background image.

8. The method of claim 1, wherein said background image is a high-quality content type, and wherein said modified background image is a compressed version of the background image satisfying the size threshold, said modified background image maintaining the high-qualities of the background image.

9. The method of claim 1, wherein said background image is based on said web content.

10. The method of claim 1, wherein said background image comprises an advertisement.

11. A non-transitory computer-readable storage medium tangibly encoded with computer-executable instructions, that when executed by a processor associated with a computing device, perform a method comprising:
receiving a request to display a web page from a user associated with a user device;
identifying said web page based on said request, said web page comprising web content, said web page associated with a background image having an original perceivable resolution;
applying a blur filter to said background image, the blur filter using settings, said settings comprising a blur radius, said blur radius set at a value that yields a modified background image having a data size at or below a data size threshold, said modified background image comprising reduced perceivable resolution when displayed;
transmitting said web page with said modified background image to said user device;
fetching said background image after initial display of said web content and said modified background image; and
transmitting said background image to said user device for display with said web content, wherein said transmission of said background image facilitates display of the background image at said original perceivable resolution.

12. The non-transitory computer-readable storage medium of claim 11, wherein said application of said blur filter comprises:
determining the size of the background image;
selecting the value of the blur radius based on said size of the background image and the size threshold; and
applying the blur filter to said background image in accordance with said blur radius.

13. The non-transitory computer-readable storage medium of claim 11, wherein said transmission of said web page with said modified background image comprises:
facilitating visible display of the web content in the foreground of modified web page; and
facilitating visible display of the modified background image in the background of the web page.

14. The non-transitory computer-readable storage medium of claim 11, further comprising:
determining a number of transitions between the modified background image to the background image in order to effectuate a smooth, non jarring transition from display of the modified background image to display of the background image;
fetching at least one second version of the background image prior to said fetching of said background image, said second version of the background image being a higher detailed version of the background image than said modified background image version; and
transmitting said second version to said user device for display with said web content, wherein said transmission of said second version facilitates blending of said second version on top of the displayed modified background image.

15. The non-transitory computer-readable storage medium of claim 14, wherein said transmission of said background image further comprises facilitating blending of said background image on top of the displayed second version of the background image.

16. The non-transitory computer-readable storage medium of claim 14, wherein said number of transitions between the modified background image to the background image is based upon at least one of the blur radius and size of the background image.

17. The non-transitory computer-readable storage medium of claim 11, wherein said blending of said background image on top of the displayed modified background image comprises applying an opacity filter to said background image.

18. The non-transitory computer-readable storage medium of claim 11, wherein said background image is a high-quality content type, and wherein said modified background image is a compressed version of the background image satisfying the size threshold, said modified background image maintaining the high-qualities of the background image.

19. A system comprising:
at least one computing device comprising:
memory storing computer-executable instructions; and
one or more processors for executing said computer-executable instructions, comprising:
receiving a request to display a web page from a user associated with a user device;
identifying said web page based on said request, said web page comprising web content, said web page associated with a background image having an original perceivable resolution;
applying a blur filter to said background image, the blur filter using settings, said settings comprising a blur radius, said blur radius set at a value that yields a modified background image having a data size at or below a data size threshold, said modified background image comprising reduced perceivable resolution when displayed;
transmitting said web page with said modified background image to said user device;
fetching said background image after initial display of said web content and said modified background image; and
transmitting said background image to said user device for display with said web content, wherein said transmission of said background image facilitates display of the background image at said original perceivable resolution.

20. The system of claim 19, further comprising:
determining a number of transitions between the modified background image to the background image in order to effectuate a smooth, non jarring transition from display of the modified background image to display of the background image;
fetching at least one second version of the background image prior to said fetching of said background image, said second version of the background image being a higher detailed version of the background image than said modified background image version; and
transmitting said second version to said user device for display with said web content, wherein said transmission of said second version facilitates blending of said second version on top of the displayed modified background image.
